(19) United States
(12) Patent Application Publication
(10) Pub. No.: US 2012/0061365 A1
(43) Pub. Date: Mar. 15, 2012

(54) Radiation heating system for vehicle

(75) Inventors: Asami Okamoto, Kariya-city (JP); Manabu Maeda, Nagoya-city (JP); Koji Ota, Kariya-city (JP)

(73) Assignee: DENSO CORPORATION, Kariya-city, Aichi-pref (JP)

(21) Appl. No.: 13/199,751

(22) Filed: Sep. 8, 2011

(30) Foreign Application Priority Data
Sep. 13, 2010 (JP) 2010-204217

(51) Int. Cl. H05B 1/00

(52) U.S. Cl. 219/202

(57) ABSTRACT

A radiation heating system for a vehicle includes a heating device and an exterior member. The heating device serves as a heat source and is for generating radiation heat to warm up an interior of the vehicle. The exterior member is disposed on a vehicle interior-side of the heating device. Given that: thermal transmittance of the exterior member is K′ [W/(m²−K)]; thermal transmittance of a human body is K4 [W/(m²−K)]; bloodstream temperature of the human body is Tm [K]; and surface temperature of the heating device is Th [K], K′ is set so as to satisfy a relationship expressed in: (2×Th×K′+Tm×K4)/(2×K′+K4)≦333.

### CROSS REFERENCE TO RELATED APPLICATION

This application is based on and incorporates herein by reference Japanese Patent Application No. 2010-204217 filed on Sep. 13, 2010.

### BACKGROUND OF THE INVENTION

1. Field of the Invention:

The present invention relates to a radiation heating system for a vehicle that warms up a vehicle interior by radiation heat.

2. Description of Related Art:

Conventionally, a radiation heating system for a vehicle, which includes an electric heater having a surface shape that is disposed along a surface of an interior member in a vehicle interior, a front surface member that is disposed on a surface of the electric heater, and a backside member disposed on a back side of the electric heater, is disclosed in JP-A-2010-052710.

The radiation heating system for the vehicle described in JP-A-2010-052710 limits heat release to the backside of the heating system by making lower thermal conductivity of the backside member than thermal conductivity of the front surface member, so as to efficiently perform conduction of heat to the front face.

However, in the above-described radiation heating system for the vehicle in JP-A-2010-052710, surface temperature of the heating system easily increases. Therefore, there is a problem that temperature of the system is high when an occupant of the vehicle comes in contract with the heating system.

### SUMMARY OF THE INVENTION

The present invention addresses at least one of the above disadvantages.

According to the present invention, there is provided a radiation heating system for a vehicle, including a heating means and an exterior member. The heating means serves as a heat source and is for generating radiation heat to warm up an interior of the vehicle. The exterior member is disposed on a vehicle interior-side of the heating means. Given that: thermal transmittance of the exterior member is K′ [W/(m²−K)]; thermal transmittance of a human body is K4 [W/(m²−K)]; bloodstream temperature of the human body is Tm [K]; and surface temperature of the heating means is Th [K], K′ is set so as to satisfy a relationship expressed in: (2×Th×K′+Tm×K4)/(2×K′+K4)≦333.

According to the present invention, there is also provided a radiation heating system for a vehicle, including a heating means and an exterior member. The heating means serves as a heat source and is for generating radiation heat to warm up an interior of the vehicle. The exterior member is formed in a creased shape such that the exterior member includes a plurality of crest portions and a plurality of trough portions, which are alternately arranged continuously. The heating means is disposed on a surface of each of the plurality of trough portions on a vehicle interior-side. Given that: thermal transmittance of the exterior member is K′ [W/(m²−K)]; thermal transmittance of a human body is K4 [W/(m²−K)]; bloodstream temperature of the human body is Tm [K]; and surface temperature of the heating means is Th [K], K′ is set so as to satisfy a relationship expressed in: (2×Th×K′+Tm×K4)/(2×K′+K4)≦333.

According to the present invention, there is further provided a radiation heating system for a vehicle, including a heating means and an exterior member. The heating means serves as a heat source and is for generating radiation heat to warm up an interior of the vehicle. The exterior member is formed in a paraboloid shape. The heating means is formed in a rod shape or in a planar shape. At least a part of the heating means is disposed to pass through a focus of the paraboloid shape of the exterior member. Given that: thermal transmittance of the exterior member is K′ [W/(m²−K)]; thermal transmittance of a human body is K4 [W/(m²−K)]; bloodstream temperature of the human body is Tm [K]; and surface temperature of the heating means is Th [K], K′ is set so as to satisfy a relationship expressed in: (2×Th×K′+Tm×K4)/(2×K′+K4)≦333.

### BRIEF DESCRIPTION OF THE DRAWINGS

The invention, together with additional objectives, features and advantages thereof, will be best understood from the following description, the appended claims and the accompanying drawings in which:

FIG. 1 is a schematic sectional view illustrating entire configuration of a radiation heating system for a vehicle in accordance with a first embodiment of the invention;

FIG. 2A is a plan view illustrating the heating system in accordance with the first embodiment;

FIG. 2B is a front view illustrating the heating system in accordance with the first embodiment;

FIG. 3A is a plan view illustrating a radiation heating system for a vehicle in accordance with a second embodiment of the invention;

FIG. 3B is a front view illustrating the heating system in accordance with the second embodiment;

FIG. 4 is a front view illustrating a radiation heating system for a vehicle in accordance with a third embodiment of the invention;

FIG. 5A is a plan view illustrating a radiation heating system for a vehicle in accordance with a fourth embodiment of the invention;

FIG. 5B is a front view illustrating the heating system in accordance with the fourth embodiment;

FIG. 6 is a front view illustrating a radiation heating system for a vehicle in accordance with a fifth embodiment of the invention;

FIG. 7 is a front view illustrating a radiation heating system for a vehicle in accordance with a sixth embodiment of the invention;

FIG. 8A is a front view illustrating a radiation heating system for a vehicle in accordance with a seventh embodiment of the invention;

FIG. 8B is a front view illustrating the heating system in accordance with the seventh embodiment;

FIG. 9A is a plan view illustrating a radiation heating system for a vehicle in accordance with an eighth embodiment of the invention;

FIG. 9B is a front view illustrating the heating system in accordance with the eighth embodiment;

FIG. 10 is a characteristic diagram illustrating a relationship between a heat ray transmittance of a covering member and sensation of warmth by an occupant of the vehicle in accordance with the eighth embodiment;

FIG. 11A is a plan view illustrating a radiation heating system for a vehicle in accordance with a ninth embodiment of the invention;

FIG. 11B is a front view illustrating the heating system in accordance with the ninth embodiment;

FIG. 12A is a plan view illustrating a radiation heating system for a vehicle in accordance with a tenth embodiment of the invention;

FIG. 12B is a front view illustrating the heating system in accordance with the tenth embodiment;

FIG. 13A is a plan view illustrating a radiation heating system for a vehicle in accordance with an eleventh embodiment of the invention; and

FIG. 13B is a front view illustrating the heating system in accordance with the eleventh embodiment.

### DETAILED DESCRIPTION OF THE INVENTION

Embodiments of the invention are described below with reference to the accompanying drawings. The same numerals are used in the drawings to indicate the same or equivalent parts in the following embodiments.

### First Embodiment

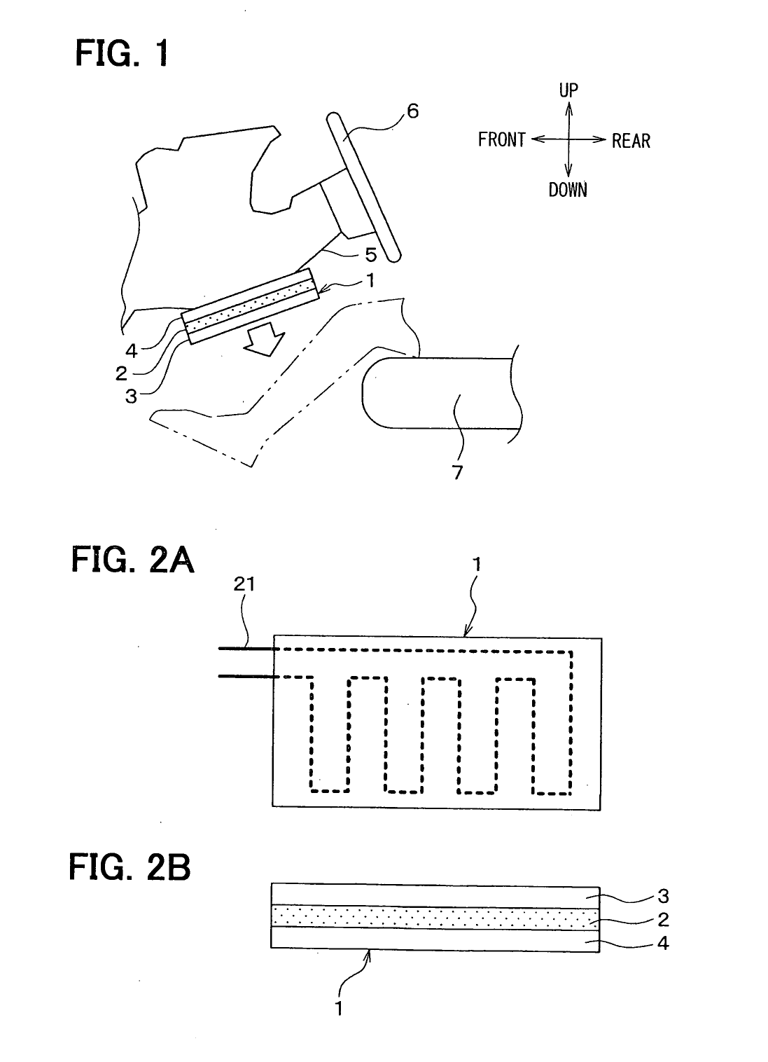

A first embodiment of the invention will be described in reference to FIGS. 1 to 2B. Directions of arrows illustrating “up, down, front, and rear” in FIG. 1 indicate a positional relation in a state in which a radiation heating system 1 for a vehicle in accordance with the first embodiment is disposed in the vehicle.

The vehicle, in which this radiation heating system 1 is disposed, also includes a heating system that warms up a vehicle interior with engine coolant as its heat source. The radiation heating system 1 of the present embodiment is used as an auxiliary heating system that is activated when the heat source for warming up the vehicle interior cannot be sufficiently obtained from the engine coolant, such as at the time of starting an engine of the vehicle, and that immediately warms up the vicinity of a foot of an occupant of the vehicle indicated by an alternate long and two short dashes line in FIG. 1.

The radiation heating system 1 for the vehicle includes an electric heater 2, an exterior member 3, and a backside member 4. The radiation heating system 1 is disposed outside an instrument panel 5 (inside the vehicle interior) that constitutes a vehicle instrument board and so forth, at a frontmost part of the vehicle interior; more specifically, on a lower surface of a steering column. A steering wheel 6, a seat 7, and so forth are also illustrated in FIG. 1 to clarify an installation position of the radiation heating system 1 in the vehicle.

The electric heater 2 includes a nichrome wire 21, which is an energizing heating body that generates heat upon energization thereof. Accordingly, in the present embodiment, the electric heater 2 may constitute a heating means, which is the heat source for generating radiation heat that warms up the vehicle interior. In the present embodiment, the electric heater 2 is formed into a surface shape. An electronic power supply is provided for the electric heater 2 from a battery through a switching means (not shown).

The exterior member 3 is disposed on the vehicle interior-side of the electric heater 2. The exterior member 3 is formed into a surface shape, and arranged so as to cover a surface of the electric heater 2 on the vehicle interior-side (hereinafter referred to also as a front surface) over its whole surface. In the present embodiment, the exterior member 3 is provided in direct contact with the front surface of the electric heater 2.

The backside member 4 is formed in a surface shape, and arranged so as to cover a surface of the electric heater 2 on its opposite side from the vehicle interior, i.e., a surface on the instrument panel 5-side (hereinafter referred to also as a backside surface) over its whole surface. In the present embodiment, the backside member 4 is provided in direct contact with the backside surface of the electric heater 2. Thermal resistance of the backside member 4 is set to be higher than thermal resistance of the exterior member 3.

Given that: a thermal transmittance of the exterior member 3 is K′ [W/(m²−K)]; a thermal transmittance of the occupant (human body) is K4 [W/(m²−K)]; a bloodstream temperature of the occupant (human body) at the normal time is Tm [K]; a bloodstream temperature of the occupant (human body) after receiving heat from the exterior member 3 in the radiation heating system 1 for the vehicle is Tj [K]; a temperature of the front surface of the electric heater 2 is Th [K]; a temperature of a contact portion between a skin of the occupant (human body) and the exterior member 3 at the time of contact stability (hereinafter referred to as a contact portion temperature) is Ts′(∞) [K]; a thermal conductivity of the exterior member 3 is λ′′[W/(m−K)]; a thickness of the exterior member 3 is d′ [m]; a heat flux from the electric heater 2 to the exterior member 3 is q4 [W/m²]; and a heat flow velocity from the exterior member 3 to the occupant (human body) is q4′ [W/m²], the following equations (3) to (5) are satisfied.

Tj=(Tm+Ts′(∞))/2 (3)

q4=K4×(Ts′(∞)−Tj) (4)

q4′=K′×(Th−Ts′(∞))=λ′/d′×(Th−Ts′(∞)) (5)

The heat flux q4 from the electric heater 2 to the exterior member 3 and the heat flow velocity q4′ from the exterior member 3 to the occupant (human body) are equal. Therefore, a relationship expressed in the following equation is satisfied.

q4=q4′ (6)

The contact portion temperature Ts′ (∞) is expressed by the following equation based on the equations (3) to (6).

Ts′ (∞)=(2×Th×K′+Tm×K4)/(2×K′+K4) (7)

In the present embodiment, the contact portion temperature Ts′ (∞) is set to be 333K (60° C.) or lower. For this reason, the thermal transmittance K′ of the exterior member 3 is set to satisfy a relationship expressed by the following equation (8).

(2×Th×K′+Tm×K4)/(2×K′+K4)≦333 (8)

As explained above, by setting the thermal transmittance K′ of the exterior member 3 to satisfy the relationship expressed by the above equation (8), the contact portion temperature Ts′ (∞) can be equal to or lower than 333K (60° C.). Thus, the temperature of the portion of the heating system 1 that is in direct contact with the occupant can be reduced.

Furthermore, by setting such that the contact portion temperature Ts′ (∞) is 313K (40° C.) or lower, i.e., by setting the thermal transmittance K′ of the exterior member 3 to satisfy a relationship expressed by the following equation (9), the temperature of the portion of the heating system 1 that is in direct contact with the occupant can be further reduced.

(2×Th×K′+Tm K4)/(2×K′+K4)≦313 (9)

In addition, by setting the thermal resistance of the backside member 4 to be higher than the thermal resistance of the exterior member 3, a heat release toward the back side (toward the backside member 4) in the radiation heating system 1 for the vehicle is limited, so that conduction of heat to the exterior member 3 can be performed efficiently. Consequently, the occupant's sensation of warmth can be efficiently improved.

### Second Embodiment

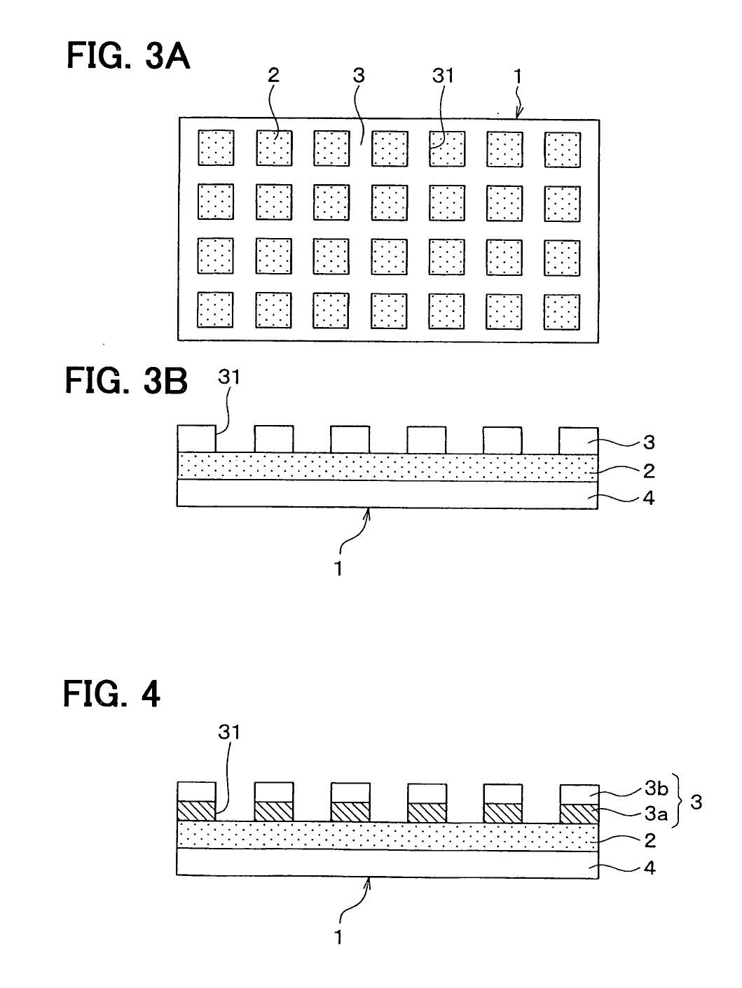

A second embodiment of the invention will be described with reference to FIGS. 3A and 3B. The second embodiment is different from the above first embodiment in formation of a through hole 31 for an exterior member 3.

As illustrated in FIGS. 3A and 3B, the through holes 31 passing through both sides of the member 3 are provided for the exterior member 3. Energy of radiation from an electric heater 2 is released directly into the vehicle interior through this through hole 31.

By forming the through hole 31 in the exterior member 3 as in the present embodiment, radiation heat of the electric heater 2 can be transmitted directly to the occupant via the through hole 31. As a result, the temperature of the portion of the heating system 1 that is in direct contact with the occupant can be decreased, and the occupant's sense of warmth can be improved.

### Third Embodiment

A third embodiment of the invention will be described with reference to FIG. 4. The third embodiment is different from the above second embodiment in that an exterior member 3 is formed in a double-layered structure.

As illustrated in FIG. 4, the exterior member 3 has the double-layered structure, which is made up of a first exterior member 3a that is in direct contact with an electric heater 2, and a second exterior member 3b that is in direct contact with the first exterior member 3a. The second exterior member 3b is disposed on the vehicle interior-side of the first exterior member 3a, and the member 3b is arranged not to be in direct contact with the electric heater 2.

The first exterior member 3a has a higher heat resistance than the second exterior member 3b. Specifically, the first exterior member 3a is made of fluorine-contained rubber or silicone rubber, and the second exterior member 3b is formed from foamed resin.

As described above, by forming the exterior member 3 into the double-layered structure, the second exterior member 3b of the exterior member 3 that is not in direct contact with the electric heater 2 can be formed from a material having a low heat resistance. Accordingly, production costs of the heating system 1 can be reduced as compared with a case of the exterior member 3 being formed in a single layer structure. Moreover, in this case, the first exterior member 3a of the exterior member 3 that is in direct contact with the electric heater 2 can also be formed from a material having a higher thermal conductivity than the second exterior member 3b.

### Fourth Embodiment

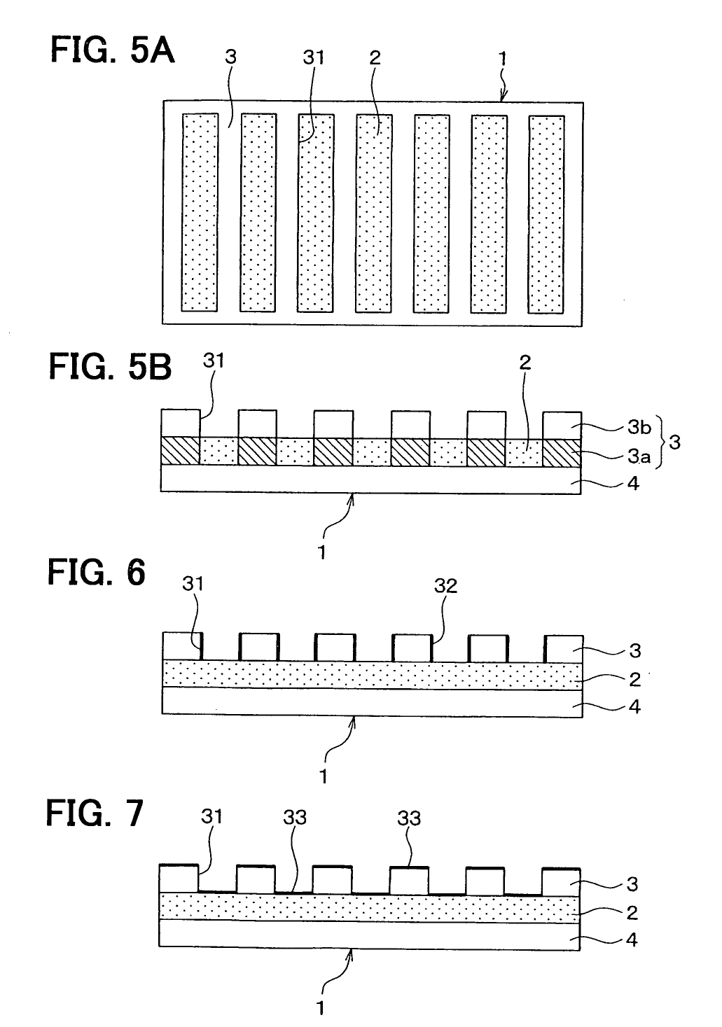

A fourth embodiment of the invention will be described in reference to FIGS. 5A and 5B. The fourth embodiment is different from the above third embodiment in that a front surface of an electric heater 2 and an exterior member 3 are not in contact.

As illustrated in FIGS. 5A and 5B, the electric heater 2 is formed in the shape of a rectangular block, and the electric heaters 2 are arranged in parallel on a surface of a backside member 4 on the vehicle interior-side. The exterior member 3 is disposed, being not in contact with a front surface of the electric heater 2, i.e., a vehicle interior-side surface of the heater 2. In other words, the electric heater 2 is inserted in a through hole 31 of the exterior member 3.

In the present embodiment, the electric heater 2 is in contact with the exterior member 3 on its side surface, i.e., on its surfaces except both surfaces of the vehicle interior-side surface and the surface that is in contact with the backside member 4. The exterior member 3 is formed into a double-layered structure as in the above third embodiment, and is configured such that a first exterior member 3a and the side surface of the electric heater 2 are in contact and a second exterior member 3b and the electric heater 2 are not in direct contact.

As explained above, by making non-contact the surface of the electric heater 2 on the vehicle interior-side and the exterior member 3, i.e., by putting them in a non-direct contact state, the amount of heat transmitted from the electric heater 2 to the exterior member 3 can be reduced. Thus, temperature of a portion of the exterior member 3 that is in direct contact with the occupant can be further decreased. Additionally, in this case, the first exterior member 3a can also be formed from metal having a higher thermal conductivity than resin.

### Fifth Embodiment

A fifth embodiment of the invention will be described in reference to FIG. 6. The fifth embodiment is different from the above second embodiment in that an inner peripheral surface of a through hole 31 is covered with a highly reflective material 32.

As illustrated in FIG. 6, the inner peripheral surface of the through hole 31 in an exterior member 3 is covered with the highly reflective material 32 having a higher reflectance than the exterior member 3. For instance, aluminum may be used for the highly reflective material 32.

In the present embodiment, absorption of radiation heat from the electric heater 2 into the inner peripheral surface of the through hole 31 in the exterior member 3 can be limited. Therefore, the occupant can receive more radiation heat from the electric heater 2. Consequently, the occupant's sensation of warmth can be further improved.

### Sixth Embodiment

A sixth embodiment of the invention will be described in reference to FIG. 7. The sixth embodiment is different from the above second embodiment in that a highly emissive material 33 is applied to surfaces of an electric heater 2 and an exterior member 3.

As illustrated in FIG. 7, the surfaces of the electric heater 2 and the exterior member 3 on the vehicle interior-side are coated with with the highly emissive material 33 having a higher emissivity than the exterior member 3.

In the present embodiment, the amount of radiation heat from the surfaces of the electric heater 2 and the exterior member 3 on the vehicle interior-side can be increased. As a result, the occupant's sensation of warmth can be further improved.

### Seventh Embodiment

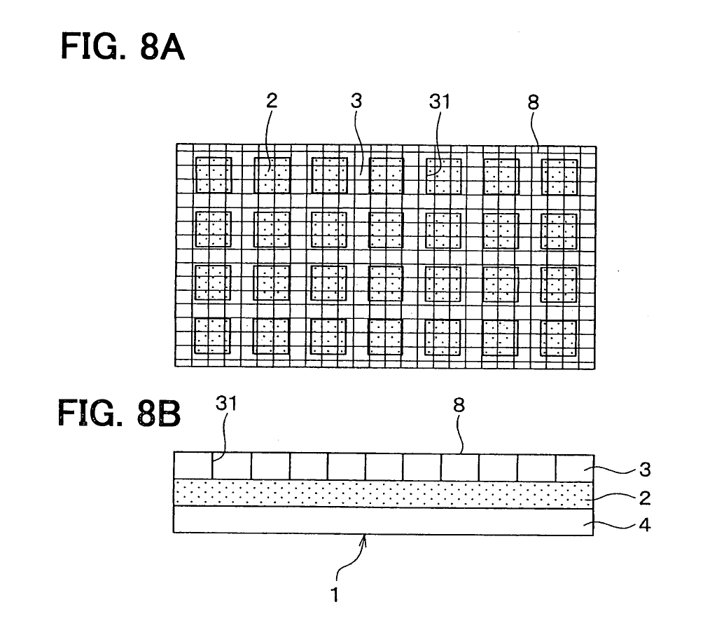

A seventh embodiment of the invention will be described in reference to FIGS. 8A and 8B. The seventh embodiment is different from the above second embodiment in that a reticulate covering member 8 is attached on a vehicle interior-side of an exterior member 3.

As illustrated in FIGS. 8A and 8B, the reticulate covering member 8 is attached on a surface of the exterior member 3 on the vehicle interior-side. This covering member 8 is formed from a material (e.g., metal) having a lower absorptance than a surface of an electric heater 2. Coarseness for reticulations of the covering member 8 is more finely formed than an opening area of a through hole 31. In the present embodiment, the roughness for reticulations of the covering member 8 is set at such a fineness that the occupant's finger does not pass through the reticulations.

As described above, by attaching the covering member 8 on the vehicle interior-side of the exterior member 3, a direct contact of the occupant's finger or the like with the electric heater 2 through the through hole 31 can be limited owing to the covering member 8 despite the increase of a diameter of the through hole 31. When the diameter of the through hole 31 formed in the exterior member 3 is increased, the amount of radiation heat that can be transmitted directly to the occupant through the through hole 31 can be increased.

In consequence, by attaching the covering member 8 on the vehicle interior-side of the exterior member 3, the direct contact of the occupant's finger or the like with the electric heater 2 via the through hole 31 is limited, and the occupant's sense of warmth can be further improved.

By making lower the absorptance of the covering member 8 than absorptance of the surface of the electric heater 2 on the vehicle interior-side, the absorption of radiation heat from the electric heater 2 into the covering member 8 can be limited.

### Eighth Embodiment

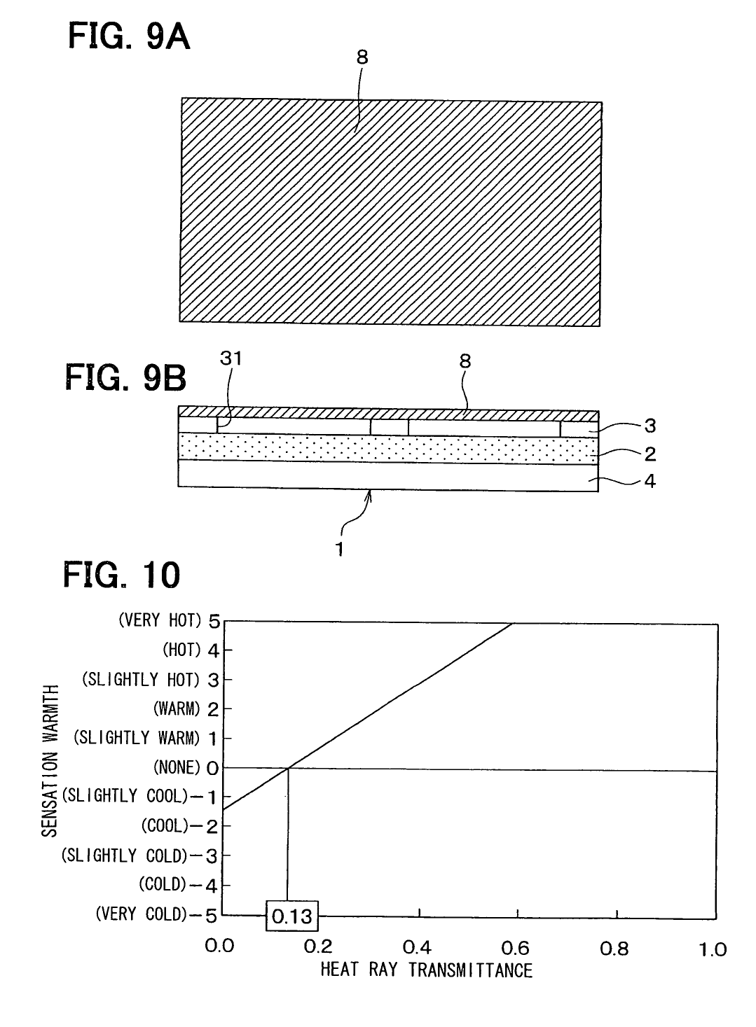

An eighth embodiment of the invention will be described with reference to FIGS. 9A to 10. The eighth embodiment is different from the above seventh embodiment in that a covering member 8 is formed from resin having heat ray permeability.

As illustrated in FIGS. 9A and 9B, the covering member 8 of the present embodiment is formed in the shape of a flat plate, and made of the resin having heat ray permeability (hereinafter referred to as heat ray permeable resin). For example, PET film (film made of polyethylene terephthalate) may be employed for the heat ray permeable resin.

A horizontal axis in FIG. 10 indicates heat-ray transmittance of the covering member 8, and a vertical axis in FIG. 10 indicates the occupant's sensation of warmth. Calculation conditions for FIG. 10 are set such that: surface temperature of an electric heater 2 is 300° C.; an area of a front surface of the electric heater 2 is 300×300 mm; and a shape factor is 0.126.

In order to ensure minimum performance of the radiation heating system 1 for the vehicle, the sensation of warmth that is 0 (zero:none) or higher needs to be given to the occupant. For this reason, based on FIG. 10, in the present embodiment, the heat ray transmittance of the covering member 8 is set at 0.13 or larger.

As explained above, by forming the covering member 8 from the resin having heat ray permeability, the heat ray from the electric heater 2 is transmitted to the occupant through the covering member 8. Accordingly, the direct contact of the occupant's finger or the like with the electric heater 2 via the through hole 31 can be even more reliably limited, with the amount of radiation heat that can be transmitted to the occupant ensured.

### Ninth Embodiment

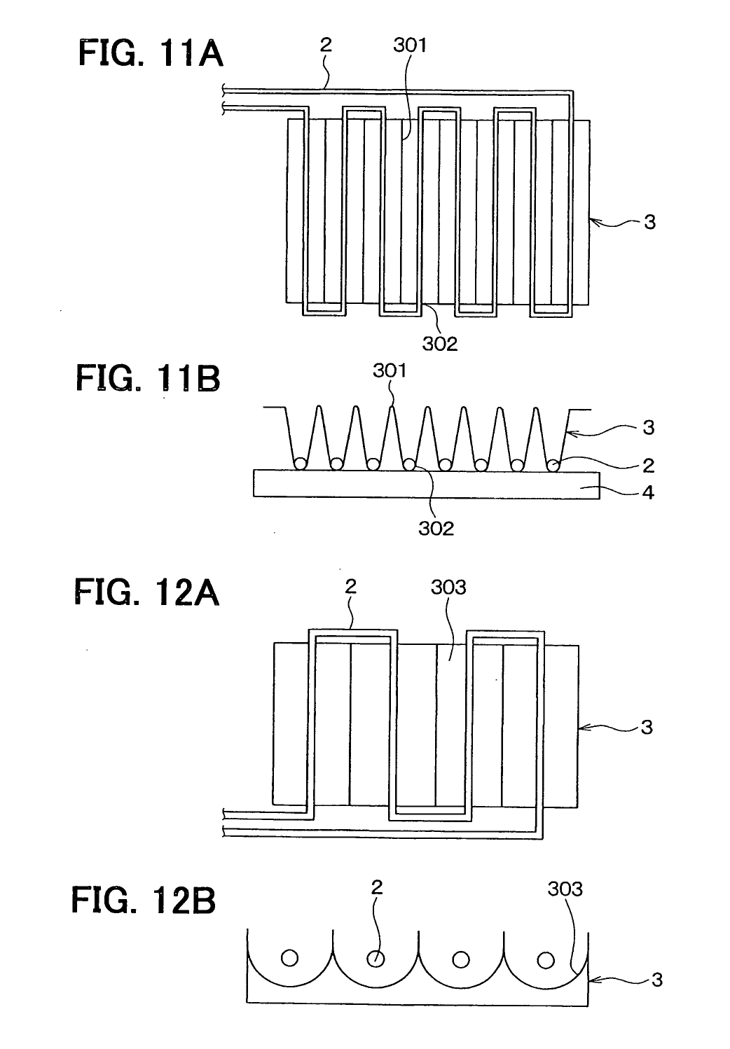

A ninth embodiment of the invention will be described in reference to FIGS. 11A and 11B. The ninth embodiment is different from the above first embodiment in that an exterior member 3 is formed into a creased shape.

As illustrated in FIGS. 11A and 11B, the exterior member 3 is formed in a creased shape such that crest portions 301 and trough portions 302 are continuously arranged alternately. A backside member 4 is disposed to be in contact with the trough portion 302 of the exterior member 3.

An electric heater 2 is formed in the shape of a rod, and formed in a meandering manner on the same plane. The electric heater 2 is disposed to be in contact with a surface of the trough portion 302 of the exterior member 3 on its opposite side from the backside member 4, i.e., a vehicle interior-side surface of the trough portion 302.

As described above, by forming the exterior member 3 into a creased shape, and by disposing the electric heater 2 on the surface of the trough portion 302 of the exterior member 3 on the opposite side from the backside member 4, radiation heat of the electric heater 2 can be directly transmitted to the occupant. As a result, the temperature of the portion of the heating system 1 that is in direct contact with the occupant can be decreased, and the occupant's sense of warmth can be improved.

### Tenth Embodiment

A tenth embodiment of the invention will be described in reference to FIGS. 12A and 12B. The tenth embodiment is different from the above ninth embodiment in that a surface of an exterior member 3 is formed in a parabolic manner in cross-section.

As illustrated in FIGS. 12A and 12B, the surface of the exterior member 3, i.e., a vehicle interior-side surface of the exterior member 3 is formed in a parabolic shape in cross-section. Specifically, half-cylindrical surfaces 303 (four surfaces 303 in the present embodiment), each of which is formed in a parabolic manner in cross-section and extends in a direction perpendicular to the symmetry axis of this parabola, are arranged in parallel on the surface of the exterior member 3.

The electric heater 2 is disposed to pass through the focus of the parabola of each half-cylindrical surface 303. The electric heater 2 and the half-cylindrical surface 303 are not in contact.

As described above, by forming the exterior member 3 in a parabolic manner in cross-section, and by disposing the rod-shaped electric heater 2 to pass through the focus of the parabola of the exterior member 3, an electromagnetic wave generated in the electric heater 2 can be reflected to make a parallel electromagnetic wave traveling in a direction parallel to the symmetry axis of this paraboloidal surface. Thus, the radiation heat of the electric heater 2 can be directly transmitted to the occupant even more effectively. As a consequence, the temperature of the portion of the heating system 1 that is in direct contact with the occupant can be decreased, and the occupant's sense of warmth can be further improved.

### Eleventh Embodiment

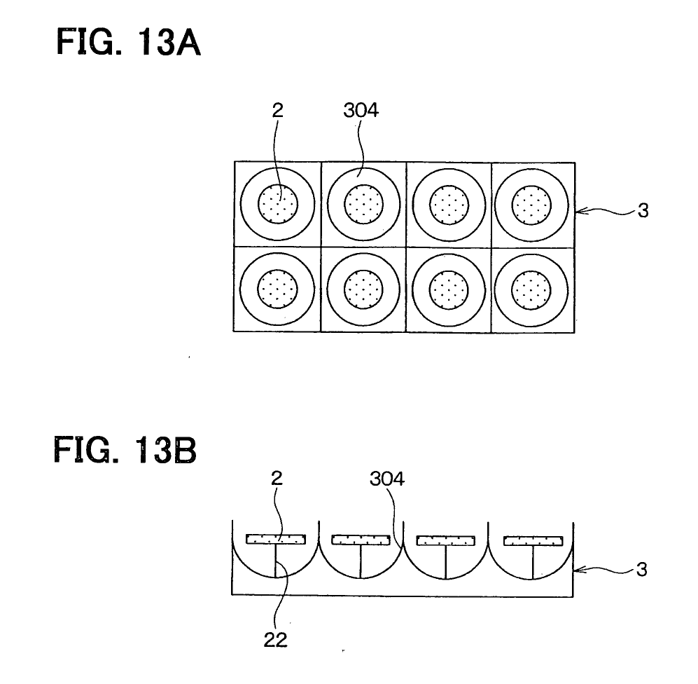

An eleventh embodiment of the invention will be described in reference to FIGS. 13A and 13B. The eleventh embodiment is different from the above tenth embodiment in that a surface of an exterior member 3 is formed in the shape of paraboloid of revolution, and an electric heater 2 is formed in the shape of a circular disk.

As illustrated in FIGS. 13A and 13B, paraboloidal surfaces 304 of revolution are formed on the surface of the exterior member 3, i.e., a vehicle interior-side surface of the exterior member 3. The planar electric heater 2 is disposed inside each paraboloidal surface 304. In the present embodiment, the electric heater 2 is formed in the shape of a circular disk.

The electric heater 2 is disposed such that the center of its shape of the circular disk passes through the focus of the paraboloidal surface 304. The electric heater 2 and the paraboloidal surface 304 are not in contact. The electric heater 2 is fixed to the paraboloidal surface 304 by a supporting member 22 on its backside surface (surface on the opposite side from a vehicle interior-side surface of the heater 2).

As described above, by forming the exterior member 3 into the shape of paraboloid of revolution and by disposing the circular disk-shaped electric heater 2 such that the center of the heater 2 passes through the focal point of the paraboloidal surface 304 of revolution of the exterior member 3, an electromagnetic wave generated in the electric heater 2 can be reflected to make a parallel electromagnetic wave traveling in a direction parallel to the symmetry axis of this paraboloidal surface. Thus, the radiation heat of the electric heater 2 can be directly transmitted to the occupant even more effectively. As a consequence, the temperature of the portion of the heating system 1 that is in direct contact with the occupant can be decreased, and the occupant's sense of warmth can be further improved.

Modifications of the above embodiments will be described. The invention is not limited to the above embodiments, and, without departing from the scope of the invention, may be modified variously as follows.

Firstly, the example of formation of the exterior member 3, in which the through holes 31 are formed, into the double-layered structure has been described in the above third embodiment. Instead of this, an exterior member 3, in which the through hole is not formed, i.e., which is formed in a planar manner, may be formed into a double-layered structure.

Secondly, the example of the front surface of the electric heater 2 and the exterior member 3, which is formed in the double-layered structure, being not in contact has been explained in the above fourth embodiment. Instead of this, a front surface of an electric heater 2 and an exterior member 3, which is formed in a single layer structure, may be in non-contact. Thirdly, in the above fourth embodiment, the example of contact of the side surface of the electric heater 2 with the exterior member 3 has been described. Alternatively, a side surface of an electric heater 2 may be in non-contact with an exterior member 3.

Fourthly, the example of formation of the covering member 8 into a reticulate shape has been explained in the above seventh embodiment. Alternatively, a covering member 8 may be formed in a film shape.

Fifthly, the example of the surfaces of the electric heater 2 and the exterior member 3 being not covered with the highly emissive material 33 has been described in the above seventh embodiment. Alternatively, surfaces of an electric heater 2 and an exterior member 3 may be coated with a highly emissive material 33. In this case, by setting an absorptance of a covering member 8 to be lower than an absorptance of the highly emissive material 33, absorption of radiation heat from the electric heater 2 by the covering member 8 can be limited.

Sixthly, the above-described embodiments may be suitably combined in a combinable range.

To sum up, the radiation heating system 1 for the vehicle in accordance with the above embodiments may be described as follows.

The radiation heating system 1 for a vehicle, includes a heating means 2 and an exterior member 3. The heating means 2 serves as a heat source and is for generating radiation heat to warm up an interior of the vehicle. The exterior member 3 is disposed on a vehicle interior-side of the heating means 2. Given that: thermal transmittance of the exterior member 3 is K′ [W/(m²−K)]; thermal transmittance of a human body is K4 [W/(m²−K)]; bloodstream temperature of the human body is Tm [K]; and surface temperature of the heating means 2 is Th [K], K′ is set so as to satisfy a relationship expressed in: (2×Th×K′+Tm×K4)/(2×K′+K4)≦333.

Accordingly, the temperature Ts′ (∞) of a contacting part between the occupant's skin and the exterior member 3 at the time of contact stability can be 333K (60° C.) or lower. Thus, the temperature of the portion of the heating system 1 that is in direct contact with the occupant can be reduced.

The exterior member 3 may include a through hole 31 passing through both sides thereof.

Accordingly, radiation heat of the heating means 2 can be transmitted directly to the occupant via the through hole 31. Thus, the temperature of the portion of the heating system 1 that is in direct contact with the occupant can be decreased, and the occupant's sense of warmth can be improved.

A surface of the heating means 2 on the vehicle interior-side and the exterior member 3 may not be in contact.

Accordingly, the vehicle interior-side surface of the heating means 2 and the exterior member 3 are not in direct contact. Thus, the amount of heat transmitted from the heating means 2 to the exterior member 3 can be reduced. Thus, temperature of a portion of the exterior member 3 that is in direct contact with the occupant can be further decreased.

An inner peripheral surface of the through hole 31 of the exterior member 3 may be coated with a highly reflective material 32 having a higher reflectance than the exterior member 3.

Accordingly, absorption of radiation heat from the heating means 2 into the inner peripheral surface of the through hole 31 in the exterior member 3 can be limited. Thus, the occupant can receive more radiation heat from the heating means 2. Consequently, the occupant's sensation of warmth can be further improved.

Surfaces of the heating means 2 and the exterior member 3 on the vehicle interior-side may be coated with a highly emissive material 33 having a higher emissivity than the exterior member 3.

Accordingly, the amount of radiation heat from the vehicle interior-side surfaces of the heating means 2 and the exterior member 3 can be increased. As a result, the occupant's sensation of warmth can be further improved.

The radiation heating system 1 may further include a covering member 8 that is attached on a vehicle interior-side of the exterior member 3. The covering member 8 may cover a surface of the heating means 2 on the vehicle interior-side, with the covering member 8 being not in contact with the heating means 2. An absorptance of the covering member 8 may be lower than an absorptance of the surface of the heating means 2 on the vehicle interior-side.

As described above, by attaching the covering member 8 on the vehicle interior-side of the exterior member 3, even if the diameter of the through hole 31 is increased, the direct contact of the occupant's finger or the like with the heating means 2 through the inside of the through hole 31 can be limited by virtue of the covering member 8. When the diameter of the through hole 31 formed in the exterior member 3 is increased, the amount of radiation heat that can be transmitted directly to the occupant through the through hole 31 can be increased.

Thus, by attaching the covering member 8 on the vehicle interior-side of the exterior member 3, the occupant's sensation of warmth can be further improved with the direct contact of the occupant's finger or the like with the heating means 2 through the inside of the through hole 31 being limited.

By making an absorptance of the covering member 8 lower than than an absorptance of the vehicle interior-side surface of the heating means 2, absorption of the radiation heat from the heating means 2 by the covering member 8 can be limited.

The radiation heating system 1 may further include a covering member 8 that is attached on the vehicle interior-side of the exterior member 3. The covering member 8 may cover the surface of the heating means 2 on the vehicle interior-side, with the covering member 8 being not in contact with the heating means 2. An absorptance of the covering member 8 may be lower than an absorptance of the highly emissive material 33.

As described above, by attaching the covering member 8 on the vehicle interior-side of the exterior member 3, even if the diameter of the through hole 31 is increased, the direct contact of the occupant's finger or the like with the heating means 2 through the inside of the through hole 31 can be limited by virtue of the covering member 8. When the diameter of the through hole 31 formed in the exterior member 3 is increased, the amount of radiation heat that can be transmitted directly to the occupant through the through hole 31 can be increased.

Thus, by attaching the covering member 8 on the vehicle interior-side of the exterior member 3, the occupant's sensation of warmth can be further improved with the direct contact of the occupant's finger or the like with the heating means 2 via the through hole 31 being limited.

By making an absorptance of the covering member 8 lower than an absorptance of the highly emissive material 33, absorption of the radiation heat from the heating means 2 by the covering member 8 can be limited.

The covering member 8 may be formed in a reticulate shape or in a film shape.

The covering member 8 may be formed from resin having heat ray permeability.

Accordingly, heat rays from the heating means 2 permeates the covering member 8 to be transmitted to the occupant. Thus, the direct contact of the occupant's finger or the like with the heating means 2 via the through hole 31 can be even more reliably limited, with the amount of radiation heat that can be transmitted to the occupant ensured.

The exterior member 3 may be formed in a planar shape covering the heating means 2 across an entire surface thereof. A surface of the exterior member 3 on the vehicle interior-side may be coated with a highly emissive material 33 having a higher emissivity than the exterior member 3.

Accordingly, since the amount of radiation heat from the exterior member 3 can be increased, the occupant's sensation of warmth can be further improved.

The exterior member 3 may have a double-layered structure such that the exterior member 3 includes a first exterior member 3a that is in contact with the heating means 2 and a second exterior member 3b that is in contact with the first exterior member 3a. The first exterior member 3a may have a higher heat resistance than the second exterior member 3b.

Accordingly, because the second exterior member 3b of the exterior member 3 that is not in direct contact with the heating means 2 can be formed from a material having a low heat resistance, production costs of the heating system 1 can be reduced as compared with a case of the exterior member 3 being formed in a single layer structure.

The radiation heating system 1 may further include a backside member 4 that is disposed on a surface of the heating means 2 that is on an opposite side from the vehicle interior-side of the heating means 2. A thermal resistance of the backside member 4 may be higher than a thermal resistance of the exterior member 3.

Accordingly, heat release to a backside surface (backside member 4-side) of the radiation heating system 1 for the vehicle is curbed, and conduction of heat to the exterior member 3 can be performed efficiently. Consequently, the occupant's sensation of warmth can be efficiently improved.

The radiation heating system 1 for a vehicle, includes a heating means 2 and an exterior member 3. The heating means 2 serves as a heat source and is for generating radiation heat to warm up an interior of the vehicle. The exterior member 3 is formed in a creased shape such that the exterior member 3 includes a plurality of crest portions 301 and a plurality of trough portions 302, which are alternately arranged continuously. The heating means 2 is disposed on a surface of each of the plurality of trough portions 302 on a vehicle interior-side. Given that: thermal transmittance of the exterior member 3 is K′ [W/(m²−K)]; thermal transmittance of a human body is K4 [W/(m²−K)]; bloodstream temperature of the human body is Tm [K]; and surface temperature of the heating means 2 is Th [K], K′ is set so as to satisfy a relationship expressed in: (2×Th×K′+Tm×K4)/(2×K′+K4)≦333.

Accordingly, the temperature Ts′ (∞) of a contacting part between the occupant's skin and the exterior member 3 at the time of contact stability can be 333K (60° C.) or lower. Thus, the temperature of the portion of the heating system 1 that is in direct contact with the occupant can be reduced.

Moreover, by forming the exterior member 3 into a creased shape and by disposing the heating means 2 on a vehicle interior-side surface of the trough portion 302 of the exterior member 3, radiation heat of the heating means 2 can be directly transmitted to the occupant. Thus, the temperature of the portion of the heating system 1 that is in direct contact with the occupant can be decreased, and the occupant's sense of warmth can be improved.

The radiation heating system 1 may further include a backside member 4 that is disposed to be in contact with a surface of each of the plurality of trough portions 302 that is on an opposite side from the vehicle interior-side. A thermal resistance of the backside member 4 may be higher than a thermal resistance of the exterior member 3.

Accordingly, heat release to a backside surface (backside member 4-side) of the radiation heating system 1 for the vehicle is curbed, and conduction of heat to the exterior member 3 can be performed efficiently. Consequently, the occupant's sensation of warmth can be efficiently improved.

The radiation heating system 1 for a vehicle, includes a heating means 2 and an exterior member 3. The heating means 2 serves as a heat source and is for generating radiation heat to warm up an interior of the vehicle. The exterior member 3 is formed in a paraboloid shape. The heating means 2 is formed in a rod shape or in a planar shape. At least a part of the heating means 2 is disposed to pass through a focus of the paraboloid shape of the exterior member 3. Given that: thermal transmittance of the exterior member 3 is K′ [W/(m²−K)]; thermal transmittance of a human body is K4 [W/(m²−K)]; bloodstream temperature of the human body is Tm [K]; and surface temperature of the heating means 2 is Th [K], K′ is set so as to satisfy a relationship expressed in: (2×Th×K′+Tm×K4)/(2×K′+K4)≦333.

Accordingly, the temperature Ts′ (∞) of a contacting part between the occupant's skin and the exterior member 3 at the time of contact stability can be 333K (60° C.) or lower. Thus, the temperature of the portion of the heating system 1 that is in direct contact with the occupant can be reduced.

Furthermore, by forming the exterior member 3 into a paraboloid shape and by disposing the heating means 2 such that at least a part of the heating means 2 passes through the focus of the paraboloid shape of the exterior member 3, an electromagnetic wave produced at the heating means 2 arranged at the focus of the paraboloid shape is reflected so as to form a parallel electromagnetic wave progressing in a direction parallel to the symmetry axis of the paraboloid. Thus, the radiation heat of the heating means 2 can be directly transmitted to the occupant even more effectively. As a consequence, the temperature of the portion of the heating system 1 that is in direct contact with the occupant can be decreased, and the occupant's sense of warmth can be further improved.

K′ may be set so as to satisfy a relationship expressed in: (2×Th×K′+Tm×K4)/(2×K′+K4)≦313.

Accordingly, the temperature Ts′ (∞) of a contacting part between the occupant's skin and the exterior member 3 at the time of contact stability can be 313K (40° C.) or lower. Thus, the temperature of the portion of the heating system 1 that is in direct contact with the occupant can be further reduced.

The heating means 2 may have positive temperature coefficient (PTC) properties.

Accordingly, the heating means 2 has a self-temperature adjustment function of increasing a resistance value upon increase of its temperature so as to reach a predetermined temperature. Thus, the high-security radiation heating system 1 for the vehicle, which eliminates the need for temperature control, can be realized.

Additional advantages and modifications will readily occur to those skilled in the art. The invention in its broader terms is therefore not limited to the specific details, representative apparatus, and illustrative examples shown and described.

What is claimed is:

1. A radiation heating system for a vehicle, comprising:
a heating means serving as a heat source for generating radiation heat to warm up an interior of the vehicle; and
an exterior member that is disposed on a vehicle interior-side of the heating means, wherein given that:
thermal transmittance of the exterior member is K′ [W/(m²−K)];
thermal transmittance of a human body is K4 [W/(m²−K)];
bloodstream temperature of the human body is Tm [K]; and
surface temperature of the heating means is Th [K],
K′ is set so as to satisfy a relationship expressed in: (2×Th×K′+Tm×K4)/(2×K′+K4)≦333.

2. The radiation heating system according to claim 1, wherein the exterior member includes a through hole passing through both sides thereof.

3. The radiation heating system according to claim 2, wherein a surface of the heating means on the vehicle interior-side and the exterior member are not in contact.

4. The radiation heating system according to claim 2, wherein an inner peripheral surface of the through hole of the exterior member is coated with a highly reflective material having a higher reflectance than the exterior member.

5. The radiation heating system according to claim 2, wherein surfaces of the heating means and the exterior member on the vehicle interior-side are coated with a highly emissive material having a higher emissivity than the exterior member.

6. The radiation heating system according to claim 5, further comprising a covering member that is attached on the vehicle interior-side of the exterior member, wherein:
the covering member covers the surface of the heating means on the vehicle interior-side, with the covering member being not in contact with the heating means; and
an absorptance of the covering member is lower than an absorptance of the highly emissive material.

7. The radiation heating system according to claim 6, wherein the covering member is formed in a reticulate shape or in a film shape.

8. The radiation heating system according to claim 6, wherein the covering member is formed from resin having heat ray permeability.

9. The radiation heating system according to claim 2, further comprising a covering member that is attached on a vehicle interior-side of the exterior member, wherein:
the covering member covers a surface of the heating means on the vehicle interior-side, with the covering member being not in contact with the heating means; and
an absorptance of the covering member is lower than an absorptance of the surface of the heating means on the vehicle interior-side.

10. The radiation heating system according to claim 9, wherein the covering member is formed in a reticulate shape or in a film shape.

11. The radiation heating system according to claim 9, wherein the covering member is formed from resin having heat ray permeability.

12. The radiation heating system according to claim 1, wherein:
the exterior member is formed in a planar shape covering the heating means across an entire surface thereof; and
a surface of the exterior member on the vehicle interior-side is coated with a highly emissive material having a higher emissivity than the exterior member.

13. The radiation heating system according to claim 1, wherein:
the exterior member has a double-layered structure such that the exterior member includes a first exterior member that is in contact with the heating means and a second exterior member that is in contact with the first exterior member; and
the first exterior member has a higher heat resistance than the second exterior member.

14. The radiation heating system according to claim 1, further comprising a backside member that is disposed on a surface of the heating means that is on an opposite side from the vehicle interior-side of the heating means, wherein a thermal resistance of the backside member is higher than a thermal resistance of the exterior member.

15. The radiation heating system according to claim 1, wherein K′ is set so as to satisfy a relationship expressed in: ((2×Th×K′+Tm×K4)/(2×K′+K4)≦313.

16. The radiation heating system according to claim 1, wherein the heating means has positive temperature coefficient (PTC) properties.

17. A radiation heating system for a vehicle, comprising:
a heating means serving as a heat source for generating radiation heat to warm up an interior of the vehicle; and
an exterior member that is formed in a creased shape such that the exterior member includes a plurality of crest portions and a plurality of trough portions, which are alternately arranged continuously, wherein:
the heating means is disposed on a surface of each of the plurality of trough portions on a vehicle interior-side; and
given that:
thermal transmittance of the exterior member is K′ [W/(m²−K)];
thermal transmittance of a human body is K4 [W/(m²−K)];
bloodstream temperature of the human body is Tm [K]; and
surface temperature of the heating means is Th [K],
K′ is set so as to satisfy a relationship expressed in: (2×Th×K′+Tm×K4)/(2×K′+K4)≦333.

18. The radiation heating system according to claim 17, further comprising a backside member that is disposed to be in contact with a surface of each of the plurality of trough portions that is on an opposite side from the vehicle interior-side, wherein a thermal resistance of the backside member is higher than a thermal resistance of the exterior member.

19. The radiation heating system according to claim 17, wherein K is set so as to satisfy a relationship expressed in: (2×Th×K′+Tm×K4)/(2×K′+K4)≦313.

20. The radiation heating system according to claim 17, wherein the heating means has positive temperature coefficient (PTC) properties.

21. A radiation heating system for a vehicle, comprising:
a heating means serving as a heat source for generating radiation heat to warm up an interior of the vehicle; and
an exterior member that is formed in a paraboloid shape, wherein:
the heating means is formed in a rod shape or in a planar shape;
at least a part of the heating means is disposed to pass through a focus of the paraboloid shape of the exterior member; and
given that:
thermal transmittance of the exterior member is K′ [W/(m²−K)];
thermal transmittance of a human body is K4 [W/(m²−K)];
bloodstream temperature of the human body is Tm [K]; and
surface temperature of the heating means is Th [K],
K is set so as to satisfy a relationship expressed in: (2×Th×K′+Tm×K4)/(2×K′+K4)≦333.

22. The radiation heating system according to claim 21, wherein K′ is set so as to satisfy a relationship expressed in: (2×Th×K′+Tm×K4)/(2×K′+K4)≦313.

23. The radiation heating system according to claim 21, wherein the heating means has positive temperature coefficient (PTC) properties.
